(19) United States
(12) Patent Application Publication
(10) Pub. No.: US 2011/0187644 A1
(43) Pub. Date: Aug. 4, 2011

(54) INPUT DEVICE WITH ILLUMINATED ROLLER

(75) Inventors: Yu-Yen Shih, Taipei (TW); Chun-Nan Su, Taipei (TW); Tsung-Wen Hsueh, Taipei (TW); Yi-Shun Wang, Taipei (TW)

(73) Assignee: PRIMAX ELECTRONICS LTD., Taipei (TW)

(21) Appl. No.: 12/777,950

(22) Filed: May 11, 2010

(30) Foreign Application Priority Data
Jan. 29, 2010 (TW) 099102539

(51) Int. Cl. G06F 3/033

(52) U.S. Cl. 345/163

(57) ABSTRACT

An input device with an illuminated roller is provided. The input device includes an upper cover, a lower base, a printed circuit board and an illuminated roller module. The illuminated roller module includes a roller, an encoder, an illuminating device and a supporting member. The illuminating device is disposed within the supporting member, and includes a flexible printed circuit and plural light emitting diodes. The plural light emitting diodes are mounted on the flexible printed circuit. The supporting member has a perforation. The flexible printed circuit of the illuminating device is penetrated through the perforation of the illuminating device and is connected to the printed circuit board. As such, electricity for illuminating is transmitted to the light emitting diodes.

### FIELD OF THE INVENTION

The present invention relates to an input device with an illuminated roller, and more particularly to an input device with an illuminated roller by using a flexible printed circuit and light emitting diodes to illuminate the roller.

### BACKGROUND OF THE INVENTION

An input device with a roller (e.g. a roller mouse) is a widely-used computer peripheral device. Conventionally, the roller of the input device is operated to control scrolling of an operating window of a computer screen. Recently, the roller has an illuminating function to prompt the user. For example, a mouse with an illuminated roller is disclosed in Taiwanese Patent No. TW470910 (=U.S. Pat. No. 6,992,653), which is entitled “Pointing device with a rollable device and light source”. Hereinafter, this conventional mouse will be illustrated with reference to FIGS. 1A, 1B and 1C.

FIG. 1A is a schematic perspective view illustrating a mouse with an illuminated roller according to the prior art. As shown in FIG. 1A, the mouse 1 comprises a housing 11 and a rolling module 12.

FIG. 1B is a schematic cross-sectional view illustrating the mouse of FIG. 1A and taken along the line 2-2. As shown in FIG. 1B, the rolling module 12 of the mouse 1 comprises a roller 121, a first supporting structure 122, a second supporting structure 123, a light source 124 and an electrode wire 125. A first axis center 1211 of the roller 121 is penetrated through the first supporting structure 122. A second axis center 1212 is penetrated through the second supporting structure 123.

FIG. 1C is a schematic cross-sectional view illustrating the first axis center 1211 and the first supporting structure 122 of the mouse 1. As shown in FIG. 1C, the first axis center 1211 comprises an electrical conducting ring 12111 and a second electrically-conductive wire 12112.

Please refer to FIG. 1C again. A first end of the electrode wire 125 is penetrated through the first axis center 1211 and then connected to the light source 124. A second end of the electrode wire 125 is connected with the electrical conducting ring 12111 through the second electrically-conductive wire 12112. An electrical conduction device 1221 is fixed on the first supporting structure 122, and electrically connected with the electrical conducting ring 12111. The first axis center 1211 containing the electrical conducting ring 12111 can be in sliding contact with the electrical conduction device 1221, which is fixed on the first supporting structure 122. The electrical conduction device 1221 is connected with a power supply (not shown) through a first electrically-conductive wire 1222. As such, electricity is transmitted from the power supply to the electrical conduction device 1221 through the first electrically-conductive wire 1222, and then transmitted to the electrode wire 125 that is connected with the light source 124 through the second electrically-conductive wire 12112. After the electricity is transmitted to the light source 124, the light source 124 emits light beams 1241 to illuminate the roller 121. As such, the illuminating purpose of the rolling module 12 is achieved.

Although the conventional mouse 1 has an illuminated roller, there are still some drawbacks. For example, since the electrode wire 125 is employed to deliver electricity, the electrode wire 125 is readily subject to deformation under the weight of the light source 124 after a long-term use period. As such, the connection between the electrode wire 125 and the second electrically-conductive wire 12112 is adversely affected, and the electricity fails to be transmitted to the electrode wire 125 through the second electrically-conductive wire 12112. In addition, the illuminating function of the light source 124 is deteriorated, and the use life of the mouse 1 is shortened.

### SUMMARY OF THE INVENTION

It is an object of the present invention to provide an input device with an illuminated roller in order to prolong the use life thereof.

In accordance with an aspect of the present invention, there is provided an input device with an illuminated roller. The input device includes an upper cover, a lower base, and an illuminated roller module. The upper cover has a roller opening. A printed circuit board is accommodated within the lower base. The illuminated roller module is disposed within the lower base, and partially protruded out of the roller opening of the upper cover. The illuminated roller module includes a roller, a supporting member, an encoder and an illuminating device. The roller includes a first ring-shaped part, a roller surface and a rotating shaft. The rotating shaft is penetrated through the roller surface. A first receptacle is formed within the first ring-shaped part. The supporting member includes a second ring-shaped part and a supporting surface. The second ring-shaped part is disposed within the first receptacle of the first ring-shaped part. The first ring-shaped part is rotatable with respect to the second ring-shaped part. A recess is formed within the second ring-shaped part. A perforation is formed in the supporting surface. A supporting slice is protruded from the supporting surface for fixing the supporting member within the lower base. The encoder is used for generating an encoding signal. The encoder has a shaft hole and is connected to a conductive wire. The encoder is positioned in the recess within the second ring-shaped part. The rotating shaft of the roller is inserted into the shaft hole. The conductive wire is penetrated through the perforation and is connected with the printed circuit board. The illuminating device is disposed within the second ring-shaped part of the supporting member, and includes a flexible printed circuit and plural light emitting diodes. The plural light emitting diodes are mounted on the flexible printed circuit for illuminating the illuminated roller module. An end of the flexible printed circuit is penetrated through the perforation and is connected with the printed circuit board.

In an embodiment, the recess of the supporting member is defined by a rectangular sidewall, and the flexible printed circuit is positioned in the second ring-shaped part by enclosing the rectangular sidewall.

In an embodiment, a switch element is disposed on the printed circuit board and aligned with a first side of the lower base, and arranged under the rotating shaft of the roller. When the roller is pressed down, the switch element is triggered by the rotating shaft.

In an embodiment, the roller and the supporting member are made of transparent material.

In an embodiment, the illuminated roller module further comprises a roller rim, which is sheathed around the first ring-shaped part of the roller.

In an embodiment, the roller surface and the supporting surface are coated with reflective paint or attached by opaque pads.

In an embodiment, the input device is a mouse.

In accordance with an aspect of the present invention, there is provided an illuminated roller module for generating an encoding signal. The illuminated roller module includes a roller, a supporting member, an encoder, and an illuminating device. The roller includes a first ring-shaped part, a roller surface and a rotating shaft. The rotating shaft is penetrated through the roller surface. A first receptacle is formed within the first ring-shaped part. The supporting member includes a second ring-shaped part and a supporting surface. The second ring-shaped part is disposed within the first receptacle of the first ring-shaped part. The first ring-shaped part is rotatable with respect to the second ring-shaped part. A recess is formed within the second ring-shaped part. A perforation is formed in the supporting surface. A supporting slice is protruded from the supporting surface. The encoder is used for generating the encoding signal. The encoder has a shaft hole and is connected to a conductive wire. The encoder is positioned in the recess within the second ring-shaped part. The rotating shaft of the roller is inserted into the shaft hole. The conductive wire is penetrated through the perforation. The illuminating device is disposed within the second ring-shaped part of the supporting member, and includes a flexible printed circuit and plural light emitting diodes. The plural light emitting diodes are mounted on the flexible printed circuit. An end of the flexible printed circuit is penetrated through the perforation.

In an embodiment, the recess of the supporting member is defined by a rectangular sidewall, and the flexible printed circuit is positioned in the second ring-shaped part by enclosing the rectangular sidewall.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic perspective view illustrating a mouse with an illuminated roller according to the prior art;

FIG. 1B is a schematic cross-sectional view illustrating the mouse of FIG. 1A and taken along the line 2-2;

FIG. 1C is a schematic cross-sectional view illustrating the first axis center and the first supporting structure of the mouse as shown in FIG. 1A;

FIG. 2 is a schematic perspective view illustrating an input device according to an embodiment of the present invention;

FIG. 3 is a schematic exploded view illustrating the input device of FIG. 2;

FIG. 4A is a schematic exploded view illustrating the illuminated roller module of the mouse as shown in FIG. 2 and taken along a viewpoint;

FIG. 4B is a schematic exploded view illustrating the illuminated roller module of the mouse as shown in FIG. 2 and taken along another viewpoint; and

FIG. 5 is a schematic side view illustrating the illuminated roller module of the mouse as shown in FIG. 2.

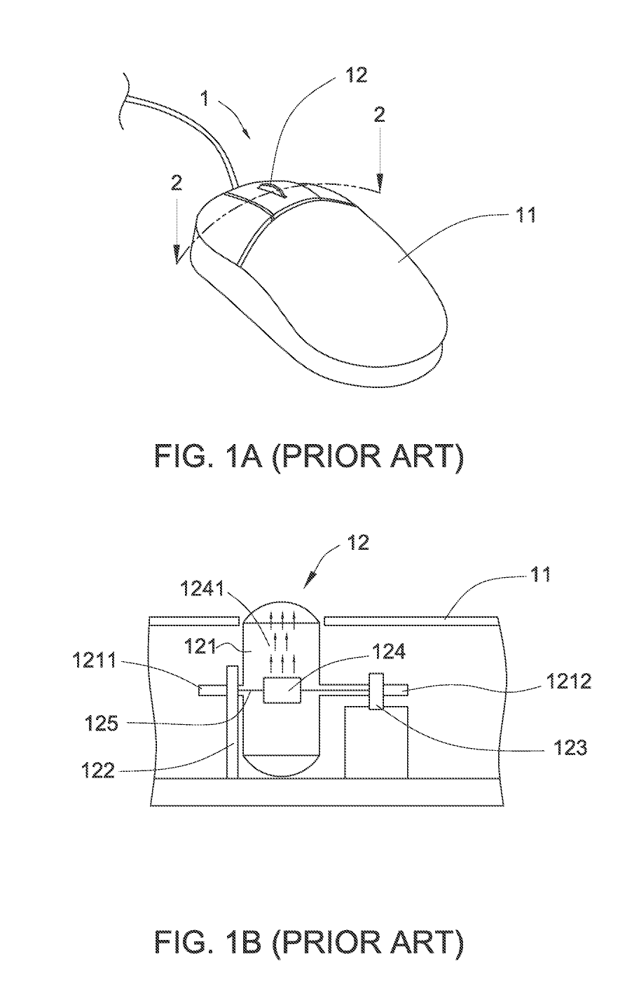

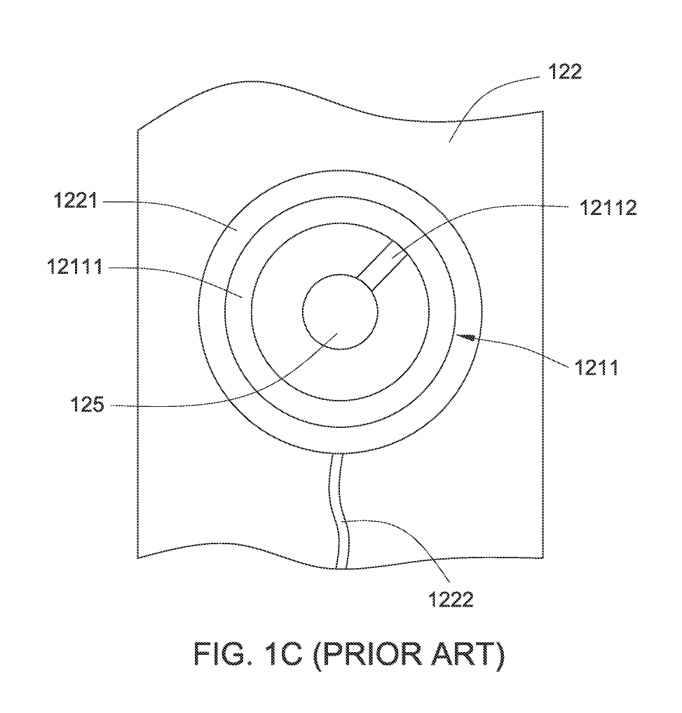

### DETAILED DESCRIPTION OF THE PREFERRED EMBODIMENT

The present invention provides an input device with an illuminated roller. In accordance with a key feature of the present invention, plural light emitting diodes are mounted on a flexible printed circuit (FPC) in order to obviate the drawbacks encountered from the prior art.

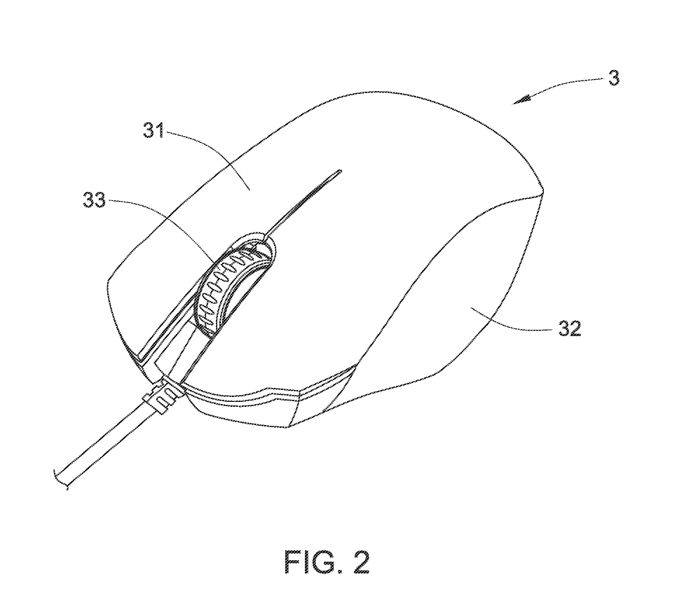

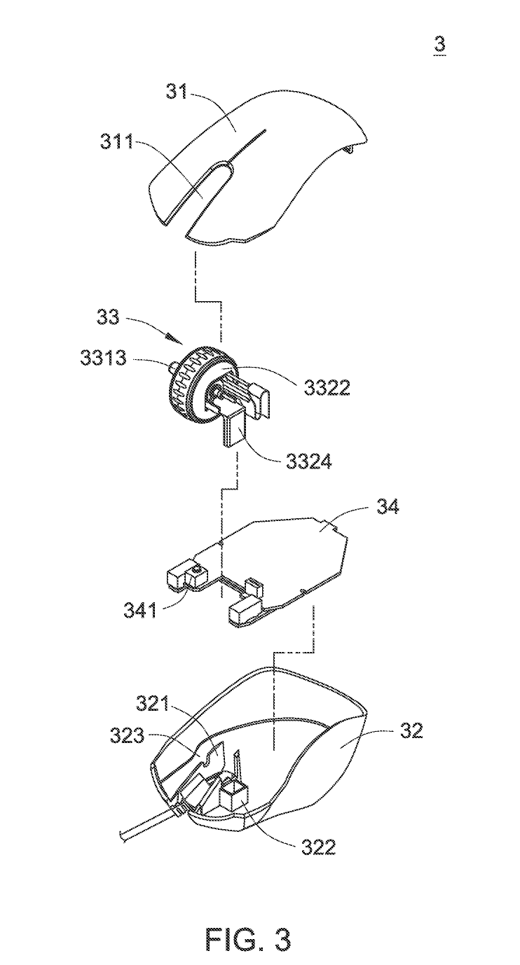

FIG. 2 is a schematic perspective view illustrating an input device according to an embodiment of the present invention. FIG. 3 is a schematic exploded view illustrating the input device of FIG. 2. In this embodiment, the input device is a mouse. As shown in FIGS. 2 and 3, the mouse 3 comprises an upper cover 31, a lower base 32, an illuminated roller module 33 and a printed circuit board (PCB) 34. The upper cover 31 has a roller opening 311. The illuminated roller module 33 is partially protruded out of the roller opening 311 of the upper cover 31, so that the illuminated roller module 33 could be manipulated by the user. A rotating shaft stand 321 and a supporting seat 322 are disposed on a front side of the lower base 32 of the mouse 3. The printed circuit board 34 is accommodated within the internal space of the lower base 32.

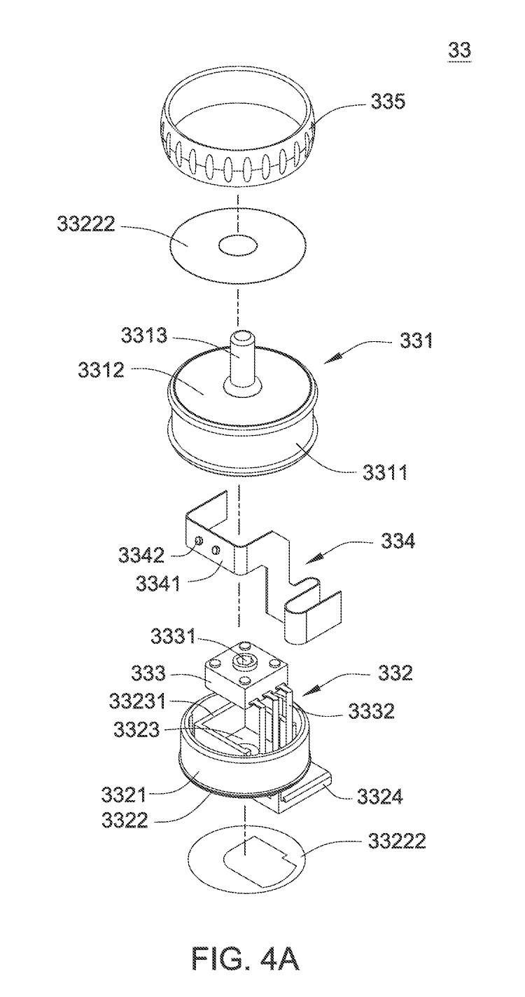

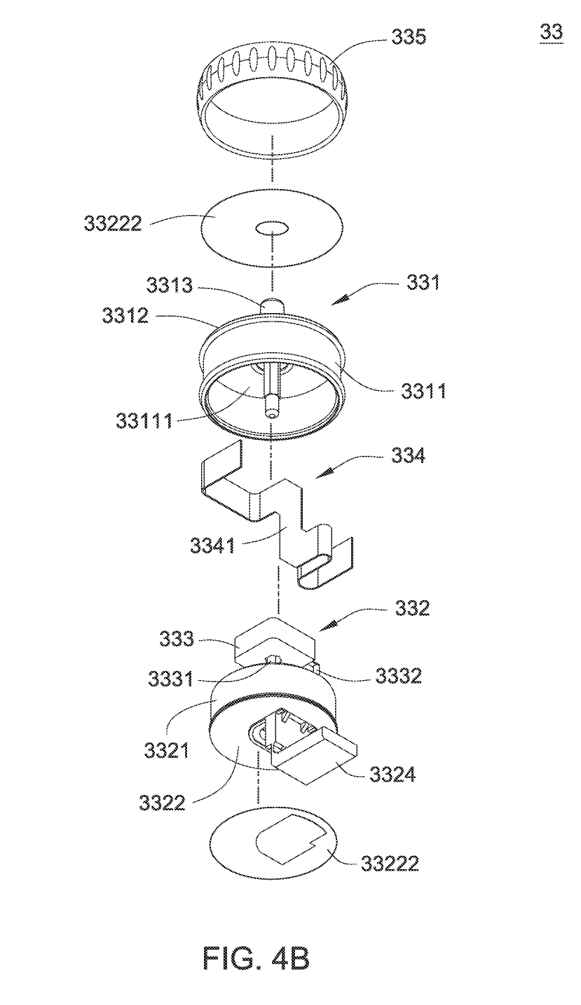

FIG. 4A is a schematic exploded view illustrating the illuminated roller module of the mouse as shown in FIG. 2 and taken along a viewpoint. FIG. 4B is a schematic exploded view illustrating the illuminated roller module of the mouse as shown in FIG. 2 and taken along another viewpoint. Please refer to FIGS. 3, 4A and 4B. As shown in FIG. 4A, the illuminated roller module 33 comprises a roller 331, a supporting member 332, and encoder 333 and an illuminating device 334. The roller 331 comprises a first ring-shaped part 3311, a roller surface 3312 and a rotating shaft 3313. The rotating shaft 3313 is penetrated through the roller surface 3312. A first receptacle 33111 is formed within the first ring-shaped part 3311. For enhancing the hand feel of rotating the illuminated roller module 33, a roller rim 335 is sheathed around the first ring-shaped part 3311 of the roller 331. The rotating shaft 3313 is disposed on the rotating shaft stand 321, so that the roller 331 is supported by the rotating shaft stand 321.

Please refer to FIGS. 4A and 4B. The supporting member 332 comprises a second ring-shaped part 3321, a supporting surface 3322, a recess 3323 and a supporting slice 3324. The supporting slice 3324 is protruded from the supporting surface 3322 and disposed on the supporting seat 322 of the lower base 32 for fixing the supporting member 332. The second ring-shaped part 3321 is disposed within the first receptacle 33111 of the first ring-shaped part 3311 of the roller 331. As such, the first ring-shaped part 3311 is rotatable with respect to the second ring-shaped part 3321. After the roller 331 is supported by the rotating shaft stand 321 and the supporting slice 3324 is fixed by the supporting seat 322, the roller 331 of the illuminated roller module 33 is rotatable on the same plane with respect the supporting seat 322.

In this embodiment, a switch element 341 is disposed on the printed circuit board 34 and aligned with a first side 323 of the lower base 32. In addition, the switch element 341 is arranged under the rotating shaft 3313 of the roller 331. In a case that the illuminated roller module 33 is pressed down, the switch element 341 is triggered by the rotating shaft 3313 to issue a roller button signal.

Moreover, the recess 3323 within the second ring-shaped part 3321 is used for fixing the encoder 333. In this embodiment, the recess 3323 is defined by a rectangular sidewall 33231. The encoder 333 has a shaft hole 3331 and a conductive wire 3332. The rotating shaft 3313 running through the roller surface 3312 is inserted into the shaft hole 3331. As a consequence, the encoder 333 generates a corresponding encoding signal upon rotation of the roller 331. The encoding signal is outputted from the encoder 333 through the conductive wire 3332.

The illuminating device 334 of the illuminated roller module 33 is also disposed within the second ring-shaped part 3321. The illuminating device 334 comprises a flexible printed circuit (FPC) 3341 and plural light emitting diodes 3342. The plural light emitting diodes 3342 are mounted on the flexible printed circuit 3341. In this embodiment, the flexible printed circuit 3341 is positioned within the second ring-shaped part 3321 by enclosing the rectangular sidewall 33231.

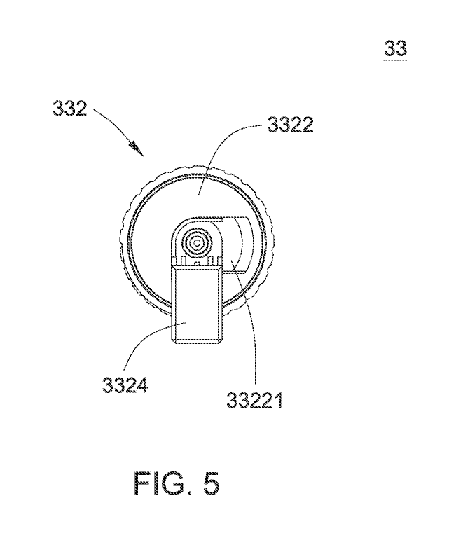

FIG. 5 is a schematic side view illustrating the illuminated roller module of the mouse as shown in FIG. 2. A perforation 33221 is formed in the supporting surface 3322 of the supporting member 332. As shown in FIGS. 4A and 4B, the conductive wire 3332 of the encoder 333 and the flexible printed circuit 3341 of the illuminating device 334 are accommodated within the second ring-shaped part 3321 and penetrated through the perforation 33221 to be connected with the printed circuit board 34. In other words, the rotation of the roller 331 will not be hindered by the conductive wire 3332 and the flexible printed circuit 3341.

For allowing the light beams emitted by the illuminating device 334 to pass through the illuminated roller module 33, the roller 331 and the supporting member 332 are preferably made of transparent material. In addition, for preventing the illuminated roller module 33 from generating unnecessary scattered light beams, the roller surface 3312 and the supporting surface 3322 are coated with reflective paint (not shown) or attached by opaque pads 33222. In this situation, most of the light beams pass through the first ring-shaped part 3311 and the second ring-shaped part 3321.

In the above embodiments, the illuminated roller module 33 is applied to a mouse. Nevertheless, the illuminated roller module 33 may be applied to any other input device such as a keyboard or a joystick.

From the above description, the present invention provides an input device with an illuminated roller. Since a flexible printed circuit with light emitting diodes is installed in a supporting member with a perforation, illuminating function is achieved without hindering from rotation of the illuminated roller. Moreover, since the encoder is integrated into the illuminated roller module, the overall volume of the illuminated roller module will be minimized and the drawbacks of using electrode wire to deliver electricity will be overcome.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An input device with an illuminated roller, said input device comprising:
an upper cover having a roller opening;
a lower base for accommodating a printed circuit board; and
an illuminated roller module disposed within said lower base, and partially protruded out of said roller opening of said upper cover, said illuminated roller module comprising:
a roller comprising a first ring-shaped part, a roller surface and a rotating shaft, wherein said rotating shaft is penetrated through said roller surface, and a first receptacle is formed within the first ring-shaped part;
a supporting member comprising a second ring-shaped part and a supporting surface, wherein said second ring-shaped part is disposed within said first receptacle of said first ring-shaped part, and said first ring-shaped part is rotatable with respect to said second ring-shaped part, wherein a recess is formed within said second ring-shaped part, a perforation is formed in said supporting surface, and a supporting slice is protruded from said supporting surface for fixing said supporting member within said lower base;
an encoder for generating an encoding signal, wherein said encoder has a shaft hole and is connected to a conductive wire, said encoder is positioned in said recess within said second ring-shaped part, said rotating shaft of said roller is inserted into said shaft hole, and said conductive wire is penetrated through said perforation and connected with said printed circuit board; and
an illuminating device disposed within said second ring-shaped part of said supporting member, and comprising a flexible printed circuit and plural light emitting diodes, wherein said plural light emitting diodes are mounted on said flexible printed circuit for illuminating said illuminated roller module, wherein an end of said flexible printed circuit is penetrated through said perforation and connected with said printed circuit board.

2. The input device according to claim 1 wherein said recess of said supporting member is defined by a rectangular sidewall, and said flexible printed circuit is positioned in said second ring-shaped part by enclosing said rectangular sidewall.

3. The input device according to claim 1 wherein a switch element is disposed on said printed circuit board and aligned with a first side of said low base, and arranged under said rotating shaft of said roller, wherein when said roller is pressed down, said switch element is triggered by said rotating shaft.

4. The input device according to claim 1 wherein said roller and said supporting member are made of transparent material.

5. The input device according to claim 1 wherein said illuminated roller module further comprises a roller rim, which is sheathed around said first ring-shaped part of said roller.

6. The input device according to claim 1 wherein said roller surface and said supporting surface are coated with reflective paint or attached by opaque pads.

7. The input device according to claim 1 wherein said input device is a mouse.

8. An illuminated roller module for generating an encoding signal, said illuminated roller module comprising:
a roller comprising a first ring-shaped part, a roller surface and a rotating shaft, wherein said rotating shaft is penetrated through said roller surface, and a first receptacle is formed within the first ring-shaped part;
a supporting member comprising a second ring-shaped part and a supporting surface, wherein said second ring-shaped part is disposed within said first receptacle of said first ring-shaped part, and said first ring-shaped part is rotatable with respect to said second ring-shaped part, wherein a recess is formed within said second ring-shaped part, a perforation is formed in said supporting surface, and a supporting slice is protruded from said supporting surface;
an encoder for generating said encoding signal, wherein said encoder has a shaft hole and is connected to a conductive wire, said encoder is positioned in said recess within said second ring-shaped part, said rotating shaft of said roller is inserted into said shaft hole, and said conductive wire is penetrated through said perforation; and
an illuminating device disposed within said second ring-shaped part of said supporting member, and comprising a flexible printed circuit and plural light emitting diodes, wherein said plural light emitting diodes are mounted on said flexible printed circuit, and an end of said flexible printed circuit is penetrated through said perforation.

9. The illuminated roller module according to claim 8 wherein said recess of said supporting member is defined by a rectangular sidewall, and said flexible printed circuit is positioned in said second ring-shaped part by enclosing said rectangular sidewall.
